(19) United States
(12) Patent Application Publication
(10) Pub. No.: US 2007/0159461 A1
(43) Pub. Date: Jul. 12, 2007

(54) Weight adjustable computer input device

(76) Inventor: Yu-Tang Zhou, San Chong (TW)

Correspondence Address: Raymond Sun, 12420 Woodhall Way, Tustin, CA, 92782, US

(21) Appl. No.: 11/329,754

(22) Filed: Jan. 11, 2006

(51) Int. Cl. G09G 5/08

(52) U.S. Cl. 345/163

(57) ABSTRACT

A computer input device has a housing having a wall with a first side and an opposing second side. A magnet is positioned on the first side, and a counterweight is positioned on the second side opposite to the magnet, with the magnet attracting the counterweight to the wall of the housing.

### BACKGROUND OF THE INVENTION

1. Field of the Invention

The present invention relates to a computer input device, and in particular, to an input device whose weight can be easily and conveniently adjusted.

2. Description of the Prior Art

Computer input devices, such as computer mice or game pads, are always provided with a fixed weight. However, some users prefer their input devices to be heavier, while others prefer their input devices to be lighter. This has resulted in a need to provide input devices where the weight can be adjusted according to the user's discretion.

An example of a known input device with an adjustable weight has a movable cartridge or drawer-like device that is positioned under the input device. The drawer-like device is capable of carrying a plurality of counterweights, which are evenly spread within the drawer. Once the user wishes to add or reduce weight to the input device, the user may add or remove counterweights from the drawer-like device. In addition, if the user further wants to change the gravity of the input device, the user may rearrange the layout of the counterweights within the drawer-like device.

However, this drawer-like device suffers from the drawback that it adds to the cost to the input device. In addition, the counterweights have to be carefully received without any clearance, otherwise sudden moving or shaking caused by the user will likely unbalance the entire input device.

### SUMMARY OF THE DISCLOSURE

It is an object of the present invention to provide a weight adjustable input device.

It is another object of the present invention to provide a weight adjustable input device which can be produced at a lower cost.

In order to accomplish the objects of the present invention, the present invention provides, in one embodiment, a computer input device having a housing that has a wall with a first side and an opposing second side. A magnet is positioned on the first side, and a counterweight is positioned on the second side opposite to the magnet, with the magnet attracting the counterweight to the wall of the housing.

In another embodiment, the computer input device has a housing, a magnet positioned on a side of the housing, and a counterweight received inside an opening of the magnet.

In yet another embodiment, the computer input device has a housing, a counterweight positioned on a side of the housing, and a magnet received inside an opening of the counterweight.

### BRIEF DESCRIPTION OF THE DRAWINGS

FIG. 1 is an exploded perspective view of a first embodiment of an input device according to the present invention.

FIG. 2 is a bottom view of the input device of FIG. 1.

FIG. 3 is an exploded perspective view of a second embodiment of an input device according to the present invention.

FIG. 4 is a bottom view of the input device of FIG. 2.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

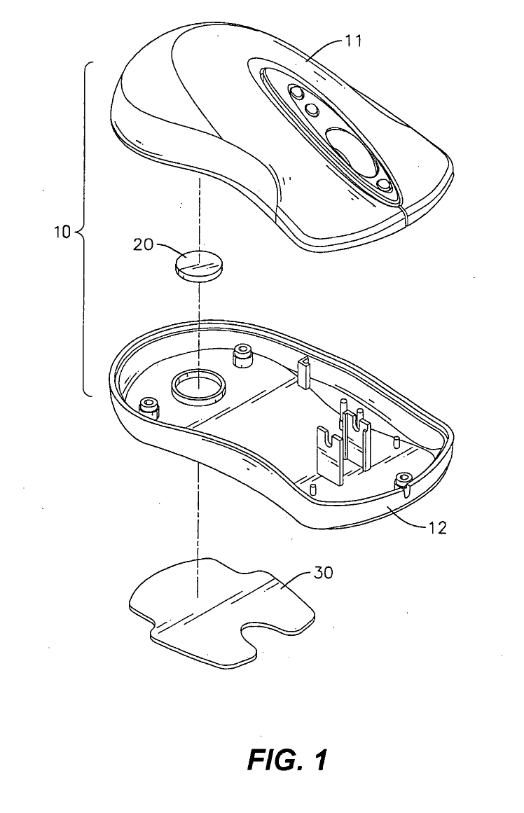

FIG. 1 illustrates a first embodiment of an input device according to the present invention. The input device can be a computer mouse or a game controller, and has a housing 10 which includes an upper housing 11 and a lower housing 12. A plurality of low-friction pads 13 are provided on the bottom of the lower housing 12. The pads 13 can be made of plastic or any material which allows the input device to be smoothly moved over a working surface, such as a desk.

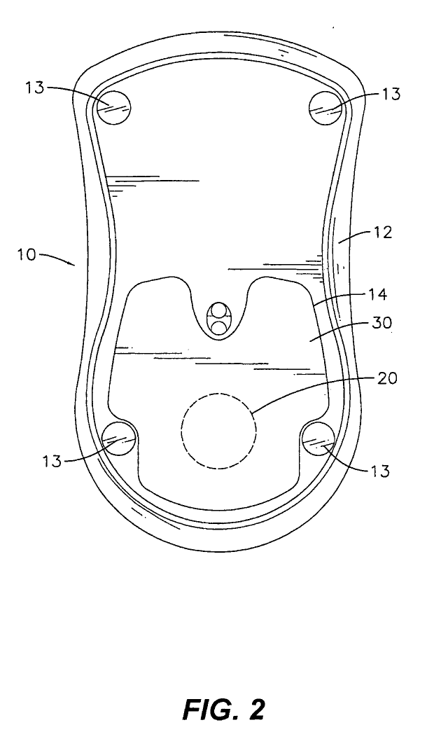

A magnet 20 is positioned on the inner side of the wall of the lower housing 12, and a counterweight 30 is located at the outer side of the wall of the lower housing 12. The counterweight 30 is provided in a material which will allow it to be attracted by the magnet 20. Referring to FIG. 2, the counterweight 30 is received within a recess 14 on the bottom of the lower housing 12 such that the counterweight 30 can be firmly held to the lower housing 12 by the attraction of the magnet 20.

The counterweight 30 may be made of magnetizable metal (such as steel or the like), and the size and the thickness of the metal can be varied. However, the maximum thickness of the counterweight 30 should not exceed the height of the pads 13.

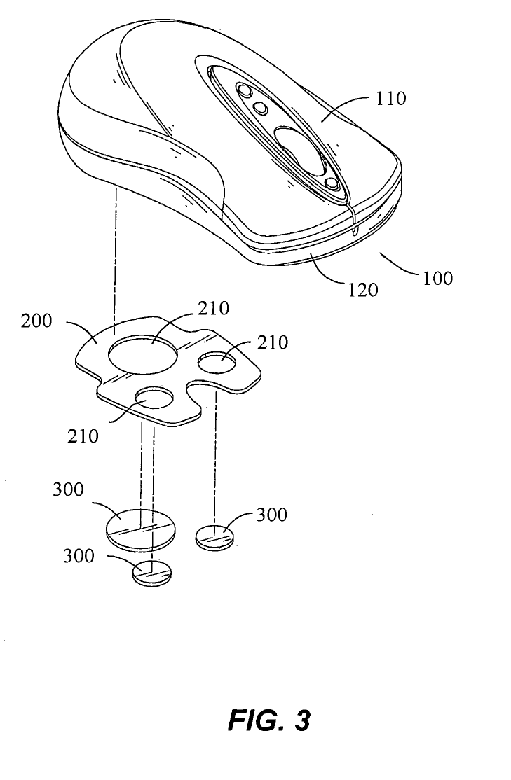

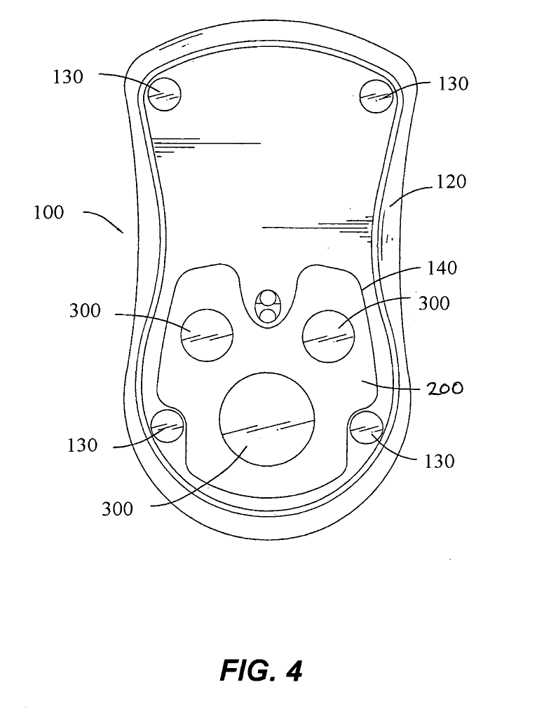

When the user wishes to change the overall weight of the input device, the user simply replaces the counterweight 30 with another counterweight 30 of a different size and/or thickness. In addition, a plurality of counterweights 30 can be stacked within the recess 14 and attracted by the magnet 20. As an alternative, it is possible to reverse the counterweight 30 to work as a magnet, and the magnet 20 to work as a counterweight. FIG. 3 illustrates a second embodiment of an input device according to the present invention. The input device can also be a mouse or a game controller, and has a housing 100 which includes an upper housing 110 and a lower housing 120. A magnet 200 having several openings 210 is positioned under the lower housing 120. A plurality of counterweights 300 can be received in the openings 210. Referring to FIG. 4, the magnet 200 is coupled and received within the recess 140 of the lower housing 120 such that the counterweights 300 can be firmly held to the lower housing 120 because of the attraction of the magnetic 200.

The counterweight 300 may be made of magnetizable metal (such as steel or the like), and the size and the thickness of the metal can be varied. However, the maximum thickness of the counterweights 300 should not exceed the height of the pads 130. Also, the openings 210 can be formed in different sizes and shapes corresponding to the sizes and shapes of the counterweights 300. If the user wishes to change the overall weight of the input device, the user simply replaces one or more counterweights 300 with counterweights 300 of different sizes and/or thicknesses. As an alternative, it is possible to reverse the counterweights 300 to work as magnets, and the magnets 200 to work as a counterweights.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A computer input device, comprising:
a housing having a wall with a first side and an opposing second side;
a magnet positioned on the first side; and
a counterweight positioned on the second side opposite to the magnet, with the magnet attracting the counterweight to the wall of the housing.

2. The input device of claim 1, wherein the second side of the housing has a recess that receives the counterweight.

3. The input device of claim 1, wherein the second side is the bottom of the housing.

4. The input device of claim 1, wherein the first side is inside the housing.

5. A computer input device, comprising:
a housing having a side;
a magnet positioned on the side of the housing, the magnet having an opening; and
a counterweight received inside the opening of the magnet.

6. The input device of claim 5, wherein the side of the housing has a recess that receives the magnet.

7. The input device of claim 5, wherein the side is the bottom of the housing.

8. A computer input device, comprising:
a housing having a side;
a counterweight positioned on the side of the housing, the counterweight having an opening; and
a magnet received inside the opening of the counterweight.

9. The input device of claim 8, wherein the side of the housing has a recess that receives the counterweight.

10. The input device of claim 8, wherein the side is the bottom of the housing.
